(19) United States
(12) Patent Application Publication
(10) Pub. No.: US 2014/0325311 A1
(43) Pub. Date: Oct. 30, 2014

(54) HYBRID ERROR CORRECTION METHOD AND MEMORY REPAIR APPARATUS THEREOF

(71) Applicant: Industrial Technology Research Institute, Hsinchu (TW)

(72) Inventors: Chih-Yen Lo, Hsinchu City (TW); Ding-Ming Kwai, Hsinchu County (TW); Jin-Fu Li, Taoyuan County (TW); Yun-Chao Yu, Taipei City (TW); Chih-Sheng Hou, Taipei City (TW)

(73) Assignee: Industrial Technology Research Institute, Hsinchu (TW)

(21) Appl. No.: 13/951,436

(22) Filed: Jul. 25, 2013

(30) Foreign Application Priority Data
Apr. 24, 2013 (TW) 102114647

(51) Int. Cl. G06F 11/10

(52) U.S. Cl. CPC G06F 11/10
USPC 714/764

(57) ABSTRACT

A hybrid error correction method and a memory repair apparatus thereof are provided for a dynamic random access memory (DRAM). The memory repair apparatus includes a mode register and a hybrid error correction code and redundancy (HEAR) module. When the DRAM enters a standby mode, the mode register switches the DRAM to be controlled by the HEAR module. The HEAR module generates parity data of the error correction code within a default refresh period. The HEAR module extends the refresh period of the DRAM and uses the parity data for error detection to locate a data retention error in the DRAM until the maximum allowable refresh period supported by the HEAR module is reached. Before the DRAM returns to a working mode from a standby mode, the HEAR module performs an error correction process according to fail bit data and writes corrected data into the DRAM.

### CROSS-REFERENCE TO RELATED APPLICATION

This application claims the priority benefit of Taiwan application serial no. 102114647, filed on Apr. 24, 2013. The entirety of the above-mentioned patent application is hereby incorporated by reference herein and made a part of this specification.

### TECHNICAL FIELD

The disclosure relates to a hybrid error correction method and a memory repair apparatus thereof

### BACKGROUND

A dynamic random access memory (DRAM) is widely used in electronic devices. A bit cell of a DRAM is composed of a storage capacitor and an access transistor. Because of leakage current, charges stored in the capacitor may leak away, thus causing data loss of the bit cell. To maintain the data integrity, to re-charge the storage capacitor through the access transistor, so as to refresh the bit cell, is required for the DRAM. In terms of the operation of the DRAM, it typically undergoes a working mode with a short burst of data read and write, followed by a very long period of a standby mode. For a mobile device, the DRAM being in the standby mode may take as long as 80% of its battery lifetime and the power consumption of the DRAM in the standby mode may take as large as 30% of the total system power consumption. Therefore, to reduce the power consumed in the standby mode of the DRAM has a significant impact on the standby time of the mobile device.

FIG. 1 illustrates a schematic diagram of an average current in the standby mode of a DRAM at different temperatures with a default refresh period. Referring to FIG. 1, the static current contributed by leakage current may be obtained by setting a refresh period of the DRAM to be excessively long. Dynamic current due to a refresh operation may be derived by subtracting the static current obtained above from the measured standby current. As illustrated in FIG. 1, the refresh current represents a significant portion of the standby current of a DRAM. Therefore, reducing the refresh power is helpful to prolong the battery lifetime.

### SUMMARY

To reduce the refresh power, a hybrid error correction method and a memory repair apparatus thereof are provided in the disclosure. The refresh power of a DRAM may be reduced on the premise that the correctness of stored data is guaranteed.

In one of exemplary embodiments, a memory repair apparatus having an error correction capability is provided to a DRAM herein. The memory repair apparatus includes a mode register and a HEAR module implementing a hybrid ECC (error correction code) and redundancy scheme. When entering a standby mode, the mode register switches the DRAM to be controlled by the HEAR module. The HEAR module is coupled to the DRAM and the mode register. After the DRAM is handed over to be controlled by the HEAR module, the HEAR module performs a burst read on the DRAM and generates parity data of an error correction code within a default refresh period. The HEAR module extends the refresh period of the DRAM for the refresh operation and performs an error detection process with the parity data generated above to locate fail bit cells resulting a data retention error in the DRAM, until the maximum allowable refresh period supported by the HEAR module is reached. The DRAM employs the extended refresh period to reduce the refresh power in the standby mode. Before the DRAM exits from the standby mode, the HEAR module performs an error correction process by both an error-bit repair (EBR) sub-module and an error correction code (ECC) sub-module, as well as writes the corrected data back into the DRAM.

In one of exemplary embodiments, a hybrid error correction method for a memory repair apparatus of a DRAM is provided. When the DRAM enters a standby mode, it is switched to be controlled by a HEAR module of the memory repair apparatus. The HEAR module performs a burst read on the DRAM and generates parity data of an error correction code within a default refresh period. The HEAR module extends the refresh period of the DRAM for the refresh operation and performs an error detection process with parity data generated above to locate fail bit cells resulting a data retention error in the DRAM. The above steps, in one of embodiments, may be repeated until the maximum allowable refresh period supported by the HEAR module is reached. The DRAM employs the extended refresh period to reduce the refresh power in the standby mode. Before the DRAM exits from the standby mode, the HEAR module performs an error correction process by both an EBR sub-module and an ECC sub-module, as well as writes the corrected data back into the DRAM.

The hybrid error correction method and the memory repair apparatus thereof are provided in the disclosure. When a DRAM enters a standby mode, it may lower the frequency to perform a refresh operation on the premise that the correctness of stored data is guaranteed. The refresh power of the DRAM may be reduced accordingly, and the standby time of an electronic device with such memory repair apparatus may thus be prolonged.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the descriptions, serve to explain the principles of the disclosure.

FIG. 1 illustrates a schematic diagram of an average current consumption in a standby mode of a DRAM with respect to different temperatures according to an exemplary embodiment.

FIG. 2 illustrates a distribution diagram of data retention time of DRAM storage cells according to an exemplary embodiment.

FIG. 3 illustrates the measured results of faulty rows containing a data retention error in a DRAM according to an exemplary embodiment.

FIG. 4 illustrates a block diagram of a memory repair apparatus with a hybrid error correction capability according to an exemplary embodiment of the disclosure.

FIG. 5 illustrates a schematic diagram of an EBR table according to an exemplary embodiment.

FIG. 6 illustrates a flowchart of a hybrid error correction method according to an exemplary embodiment of the disclosure.

FIG. 7 is a schematic diagram of the operation statuses of the DRAM 410 and the HEAR module 430 according to an exemplary embodiment of the disclosure.

FIG. 8 is a circuit diagram of the EBR sub-module 434 according to an exemplary embodiment of the disclosure.

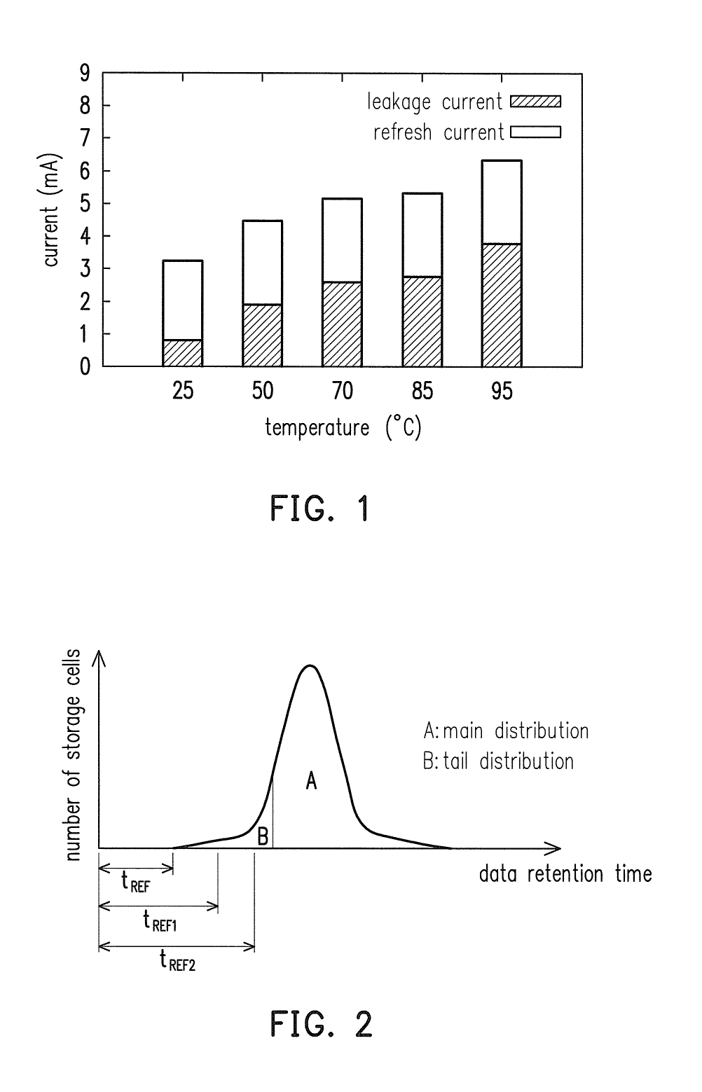

### DETAILED DESCRIPTION OF DISCLOSED EMBODIMENTS

Reducing refresh power of a dynamic random access memory (DRAM) may be achieved by extending a refresh period of the DRAM. The refresh period may be determined by the data retention time of the leakiest bit cell in the DRAM. FIG. 2 illustrates a distribution diagram of data retention time of DRAM bit cells according to an exemplary embodiment. Referring to FIG. 2, most of the bit cells may fall into a main distribution A of data retention time, while a small amount of the bit cells belong to a tail distribution B of the data retention time. Take the distribution diagram in FIG. 2 as an example. The default refresh period of the DRAM is t_{REF}. Suppose that the number of the bit cells having a data retention error in each row of the DRAM is less than or equal to 1, while the refresh period of the DRAM is extended to a first refresh period t_{REF1} (t_{REF1}>t_{REF}). Each row of the DRAM may be protected by an error correction code (ECC) technique with 1-bit error correction capability. Hence, the refresh power consumption of the DRAM may be reduced and the data integrity may be maintained, while the refresh period of the DRAM is extended to the first refresh period t_{REF}. Similarly, suppose that the number of bit cells having a data retention error in each row of the DRAM is less than or equal to 2, while the refresh period of the DRAM is extended to a second refresh period t_{REF2} (t_{REF2}>t_{REF1}). Then, each row of the DRAM may be protected by the ECC technique with 2-bit error correction capability.

Accordingly, when the ECC technique is employed to extend the refresh period of the DRAM, the correction capability of the applied ECC determines how long the refresh period may be extended to. However, the ECC with more bits of error correction capability requires more parity bits, which must also be added in the DRAM, and may lead to adverse effects such as additional leakage and refresh power induced by the parity bits.

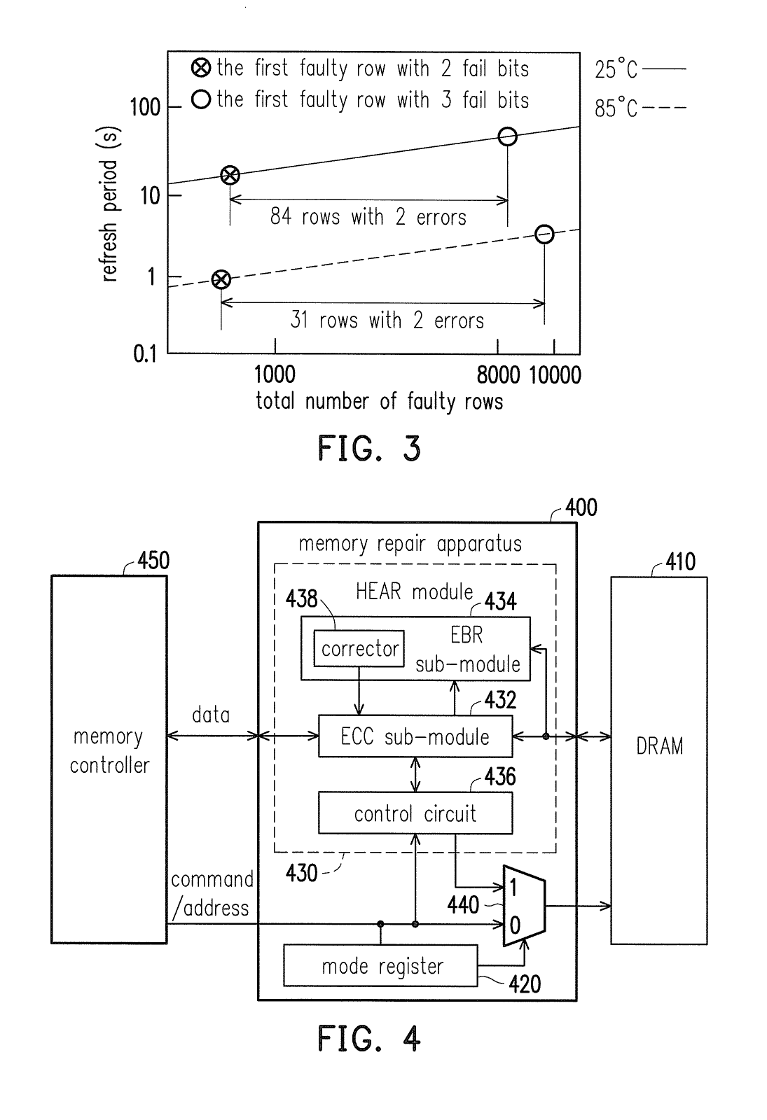

FIG. 3 illustrates measured results of data retention errors in a DRAM according to one of exemplary embodiments. Specifically, FIG. 3 records the growth of bit cells having a data retention error in each row of the DRAM, while the refresh period is extended at two temperatures 25° C. and 85° C. Referring to FIG. 3, for the temperature of 25° C., the total number of the faulty rows containing a data retention error is approximately 8000 when the refresh period is extended to the appearance of the first row with a 3-bit data retention error, among which the number of faulty rows with a 2-bit data retention error is 84. That is, when the refresh period is extended to that at most a 2-bit data retention error can occur in each row of the DRAM, most faulty rows are 1-bit data retention errors, while only a very few faulty rows are 2-bit data retention errors. However, if an ECC is used to maintain such a refresh period, 2-bit error correction capability must be employed. On other hand, if redundancy is used to repair one bit cell in the 2-bit data retention error beforehand, only a small amount of storage is needed and ECC with 1-bit error correction capability would be sufficient. Compared to the ECC with 1-bit error correction capability, the ECC with 2-bit error correction capability apparently requires more parity data just to correct a small amount of the faulty rows with 2-bit data retention errors.

Accordingly, to reduce the refresh power of the DRAM, the error correction capability of the ECC should be maximized, but the adverse effects from the parity data minimized in the disclosure. A hybrid ECC and redundancy (HEAR) scheme is provided in the disclosure to reduce the power consumption of a DRAM in a standby mode. Exemplary embodiments are provided hereafter so that this description will be thorough and complete, and will fully convey the scope of the inventive concept to those skilled in the art.

FIG. 4 illustrates a block diagram of a memory repair apparatus with a hybrid error correction capability according to one of exemplary embodiments of the disclosure. Referring to FIG. 4, a memory repair apparatus with the hybrid error correction capability 400 (referred to as a memory repair apparatus 400) in the exemplary embodiment includes a mode register 420, a HEAR module 430, and a multiplexer 440, wherein the memory repair apparatus 400 may be coupled to a DRAM 410 and a memory controller 450. It is noted that, the DRAM 410 may be replaced by, for example, a DRAM core array, and the memory controller 450 may be replaced by, for example, a peripheral circuit in another exemplary embodiment.

Each component and its function of the memory repair apparatus 400 may be described in detail hereinafter.

When the DRAM 410 enters a standby mode, the mode register 420 switches the DRAM 410 to be controlled by the HEAR module 430. On the other hand, when the DRAM 410 exits from the standby mode, the mode register 420 switches the DRAM 410 to be controlled by the memory controller 450. To be more specific, the mode register 420 may be coupled to the DRAM 410 through, for example, the multiplexer 440. When the mode register 420 receives an instruction of switching the DRAM 410 to and from the standby mode, it may perform a switching operation through the multiplexer 440.

The HEAR module 430 is coupled to the DRAM 410, the mode register 420, and the multiplexer 440. The HEAR module 430 in the exemplary embodiment applies the HEAR technique. After the DRAM 410 is handed over to be controlled by the HEAR module 430, the HEAR module 430 may perform a burst read on the DRAM 410 and generate parity data of the ECC within a default refresh period. Then, the HEAR module 430 extends the refresh period of the DRAM 410, performs the error detection process by using the parity data generated above to locate fail bit cells resulting a data retention error in the DRAM 410. Such operations may be repeated until the maximum allowable refresh period supported by the HEAR module 430 is reached. The DRAM 410 may employ such an extended refresh period so as to reduce the refresh power in the standby mode. Before the DRAM 410 exits from the standby mode, the HEAR module 430 may perform an error correction process through an error-bit repair (EBR) sub-module 434 and an error correction code (ECC) sub-module 432 as well as write corrected data back into the DRAM 410.

Referring to FIG. 4, the HEAR module 430 includes the ECC sub-module 432, the EBR sub-module 434, and a control circuit 436. Each of the components of the HEAR module 430 are described in detail hereinafter.

The control circuit 436 may set a user-defined bit in the mode register 420. Such a user-defined bit may switch the multiplexer 440 so as to manage the controllability of the DRAM 410. The control circuit 436 may further control the ECC sub-module 432 and the EBR sub-module 434 to perform the error detection process and the error correction process.

The ECC sub-module 432 may perform parity encoding by reading original data from the DRAM 410 row-wisely. When the refresh period is extended, the ECC sub-module 432 may locate the fail bit data of a data retention error. In the exemplary embodiment, the ECC sub-module 432 employs a Bose, Chaudhuri & Hocquenghem (BCH) encoding and decoding method. As energy saving is concerned, the ECC sub-module using the BCH encoding and decoding method may simply enhance the error correction capability, and yet the disclosure is not limited herein.

The EBR sub-module 434, which is coupled to the ECC sub-module 432, includes a storage space for an EBR table. The EBR table stores the fail bit data of the data retention error which is detected and located by the ECC sub-module 432. The EBR sub-module 434 may further include a corrector 438 which performs a preliminary repair.

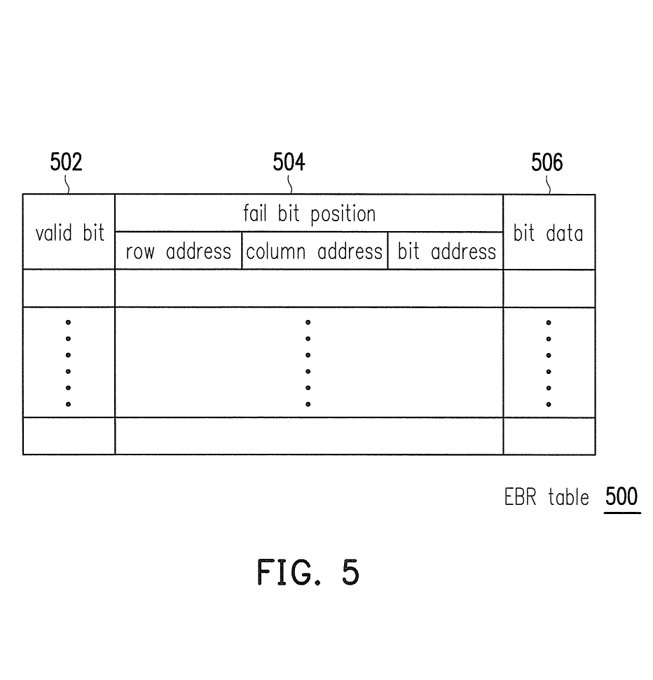

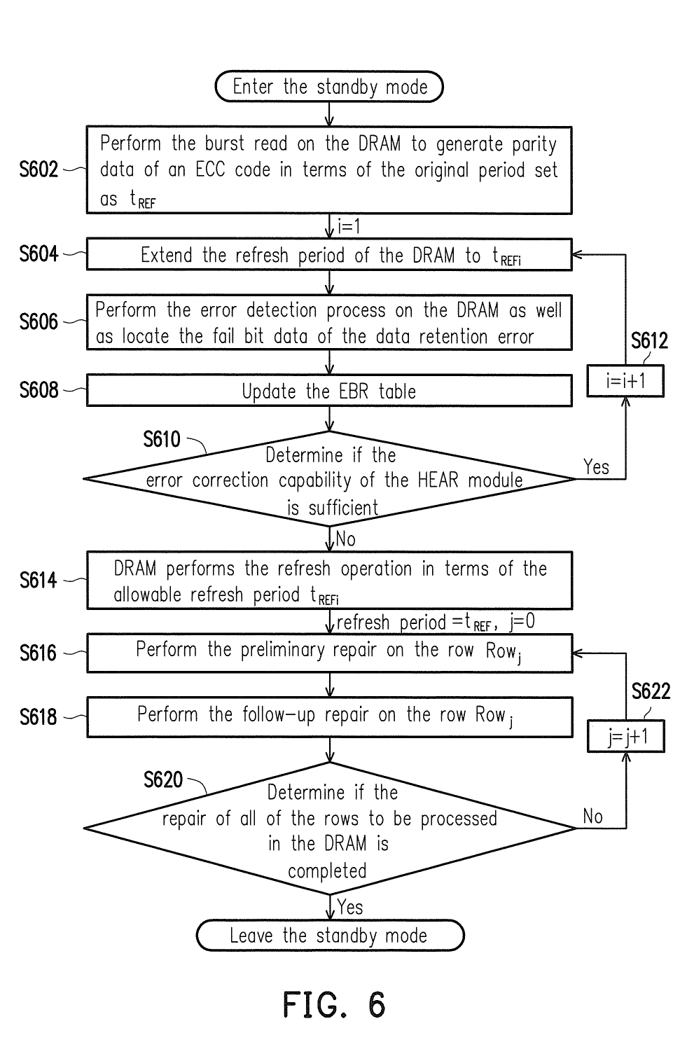

FIG. 5 illustrates a schematic diagram of an EBR table according to one of exemplary embodiments of the disclosure. Referring to FIG. 5, an EBR table 500 may include, for example, a column of valid bit 502, a column of fail bit position 504, and a column of bit data 506. The column of fail bit position 504 may further comprise a column of row address, a column of column address, and a column of bit address for the data retention error in the DRAM 410.

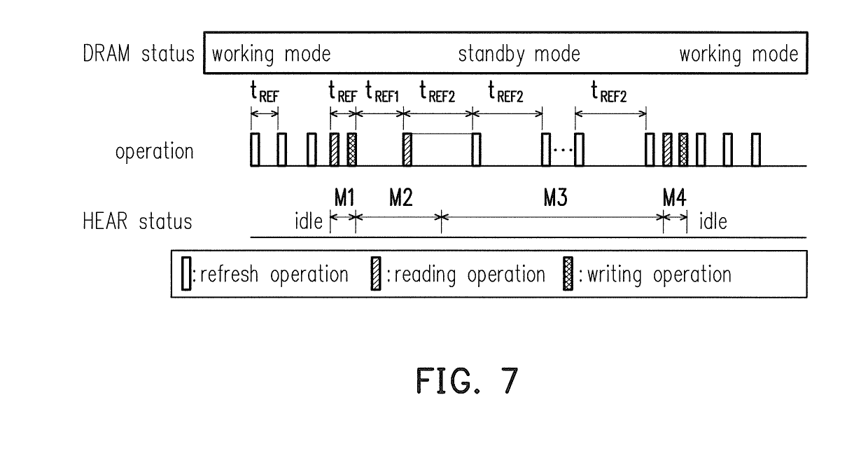

FIG. 6 illustrates a flowchart of a hybrid error correction and redundancy method according to one of exemplary embodiments of the disclosure. FIG. 7 is a schematic diagram of the operational status of the DRAM 410 and the HEAR module 430 according to an exemplary embodiment of the disclosure. The method illustrated in FIG. 6 may be adapted to the memory repair apparatus 400 in FIG. 4, and therefore may be described along with FIG. 4 and FIG. 7 hereinafter.

Referring to FIG. 4, FIG. 6, and FIG. 7, when the DRAM 410 enters to the standby mode, the original refresh period of the DRAM is set to t_{REF}, and the HEAR module 430 performs the burst read on the DRAM 410 to generate parity data of an ECC code (Step S602). As illustrated in FIG. 7, when the HEAR module 430 enters to a first status M1, the ECC sub-module 432 performs read and write operations on the DRAM 410 row-wisely using t_{REF} as the default refresh period until the original data of all of the rows are encoded to the parity data of the ECC for error detection and identification in a follow-up decoding step.

Next, the HEAR module 430 extends the refresh period of the DRAM 410 to t_{REFi} (Step S604). In the exemplary embodiment, the default refresh period t_{REF} is extended to a first refresh period t_{REFi} (i=1).

After the refresh period is extended, the ECC sub-module 432 performs the error detection process on the DRAM 410 as well as locates the fail bit data of the data retention error (Step S606). Also, the ECC sub-module 432 stores the fail bit data in the EBR sub-module 434; i.e., to update the EBR table (Step S608). Next, the error correction capability of the HEAR module 430 is determined if it is sufficient (Step S610), wherein if so, the refresh period is further extended in Step S612 (i.e. i=i+1). In the exemplary embodiment, the first refresh period t_{REF1} is extended to a second refresh period t_{REF2}, which provides a standby mode with lower power consumption.

If Step S610 is determined to be false, it represents that the maximum allowable refresh period supportable by the HEAR module 430 is reached. Meanwhile, continuing to Step S614, the DRAM 410 may continue performing the refresh operation in terms of the allowable refresh period t_{REFi}. Taking FIG. 7 as an example, the DRAM 410 may continue performing the refresh operation in terms of, for example, the second refresh period t_{REF2}. In the mean time, the HEAR module 430 is in a third status M3.

When the memory repair apparatus 400 receives a control command to exit from the standby mode, the HEAR module 430 may perform the error correction process row-wisely and write corrected data back into the DRAM 410. To be more specific, when the DRAM 410 performs the error correction process on a row Rowⱼ, the HEAR module 430 may perform comparison between the row Rowⱼ and the EBR table. If the comparison mismatches, the ECC sub-module 432 directly corrects the row Rowⱼ. If the comparison matches, the EBR sub-module 434 may first perform a preliminary repair on the row Rowⱼ, and the ECC sub-module 432 may perform a follow-up repair. In an exemplary embodiment, when the ECC sub-module 432 and the EBR sub-module 434 altogether have a 2-bit error correction capability, after the EBR sub-module 434 repairs the first fail bit, the ECC sub-module 432 may repair the second fail bit. The detail technique of the preliminary repair performed by the EBR sub-module 434 may be described hereafter.

As described in Step S616, the EBR sub-module 434 may perform the preliminary repair on the row Rowⱼ first. Then in Step S618, the ECC sub-module 432 may perform the follow-up repair on the row Rowⱼ. Lastly, all of the rows to be processed in the DRAM 410 are determined if the repair is completed (Step S620). If not, then the next row Rowⱼ (i.e. j=j+1) is entered in Step S622. When all of the rows to be processed are repaired, the DRAM 410 may return to the working mode from the standby mode.

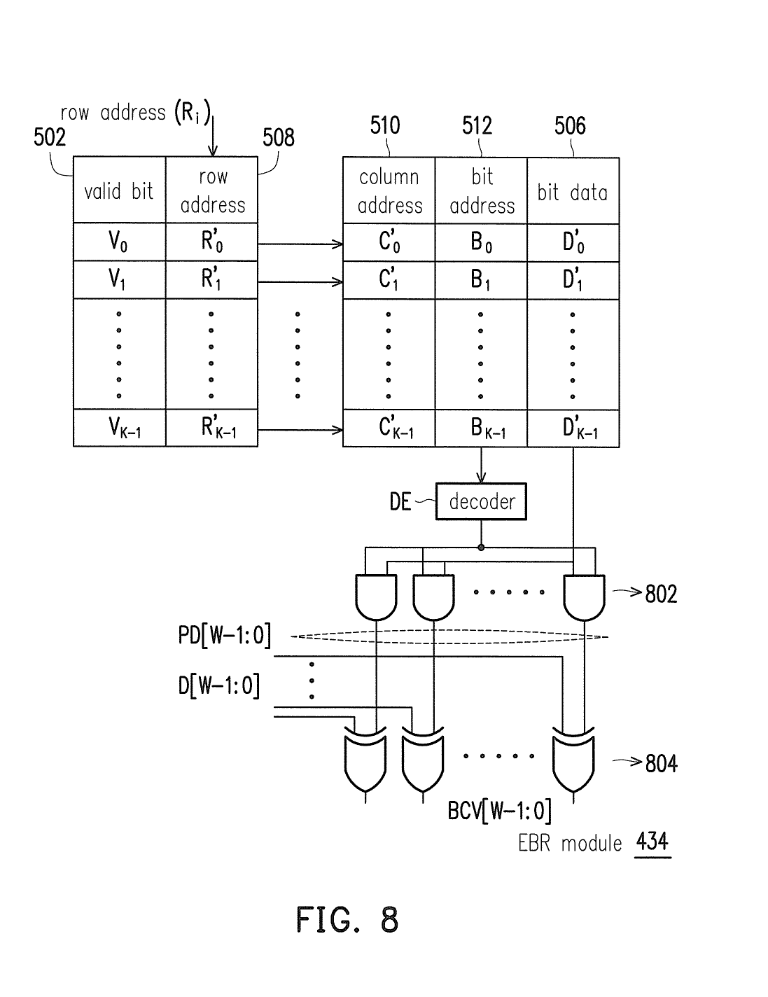

The technique of the preliminary repair used by the EBR sub-module is described in detail hereinafter. FIG. 8 is a circuit diagram of the EBR sub-module 434 according to an exemplary embodiment of the disclosure.

Referring to FIG. 8, suppose that the EBR table in the EBR sub-module 434 is capable of storing K bits of data retention error, wherein K is a positive integer. The error correction method is not done by complementing the data of the fail bit positions directly. The encoded data may be impacted by an energetic particle such that the fail bit data becomes correct in the standby mode of the DRAM and results in an incorrect correction if the data of the fail bit positions are complemented directly. Hence, the correct bit data may be first stored in the EBR sub-module 434, and the error correction operation may be performed row-wisely. When a row to be processed is in an error correction step such as Step S616 in FIG. 6, a row address Rⱼ is compared with a row address 508 stored in the EBR sub-module 434. If the comparison result mismatches, the row to be processed may be repaired by the ECC sub-module 432 directly. If the row address Rᵢ is found in the EBR table in the EBR sub-module 434, the data of the column address 510, the bit address 512, and the bit data 506 in the matched entry may be read out from the EBR table.

To be more specific, the bit address 512 may be decoded into the fail bit position of an original word by a decoder DE. Then, a position data (PD) vector is obtained by a plurality of AND gates 802 (i.e., first logic gates) with fail bit information (including a bit address Bⱼ and a bit data Dⱼ′, wherein j=0, 1, . . . K). Such a position data vector may be denoted as PD[W-1:0]. Suppose that the width of a word is W. A bit correction vector (BCV) represented as BCV[W-1:0] may be obtained by performing bit-wise XOR operation on the position data vector PD[W-1:0] and a data vector D[W-1:0] read from the DRAM. The BCV may be used to correct partial errors in the faulty rows and the partially corrected data is written back to the word in the DRAM 410. The ECC sub-module 432 may perform correction on the remaining errors in the faulty rows.

To sum up, the hybrid error correction method and the memory repair apparatus thereof are provided in the disclosure. When a DRAM enters a standby mode, it may effectively reduce the frequency of performing the refresh operation on the premise that the correctness of stored data is guaranteed. The refresh power of the DRAM may be reduced accordingly, and the standby time of an electronic device with such memory repair apparatus may thus be extended.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A memory repair apparatus to a dynamic random access memory (DRAM) having a hybrid error correction capability comprising:
a mode register, when the DRAM enters a standby mode, switching the DRAM to be controlled by a hybrid error correction code and redundancy (HEAR) module and
the HEAR module, coupled to the DRAM and the mode register, wherein after the DRAM is handed over to be controlled by the HEAR module, the HEAR module generates an error correction code according to a refresh period, extends the refresh period, and performs an error detection process to generate fail bit data of the DRAM until the refresh period is extended to an allowable refersh period,
wherein before the DRAM exits from the standby mode, the HEAR module performs an error correction process according to the fail bit data and writes corrected data back into the DRAM.

2. The memory repair apparatus having the hybrid error correction capability in claim 1, wherein the HEAR module comprises:
an error correction code (ECC) module, reading original data from the DRAM row-wisely to perform encoding, and generating the fail bit data after the refresh period is extended;
an error-bit repair (EBR) module, employing an EBR table for storing the fail bit data; and
a control circuit, setting a user-defined bit in the mode register to switch a controllabiltiy of the DRAM, and controlling the ECC sub-module and the EBR sub-module to perform the error detection process and the error correction process.

3. The memory repair apparatus having the hybrid error correction capability in claim 2, wherein the ECC sub-module employs a Bose, Chaudhuri & Hocquenghem (BCH) encoding and decoding method.

4. The memory repair apparatus having the hybrid error correction capability in claim 2, when the DRAM performs the error correction process on a row to be processed, performing a comparison between the row to be processed and the EBR table,
wherein if the comparison mismatches, the ECC sub-module performs repair on the row to be processed directly,
wherein if the comparison matches, the control circuit controls the EBR sub-module to perform a prelimiary repair on the row to be processed and then controls the ECC sub-module to perform a follow-up repair.

5. The memory repair apparatus having the hybrid error correction capability in claim 4, wherein when the ECC sub-module and the EBR sub-module altogether comprise a 2-bit error correction capability, the control circuit controls the EBR sub-module to repair a first-bit error and then controls the ECC sub-module to repair a second-bit error.

6. The memory repair apparatus having the hybrid error correction capability in claim 4, wherein the EBR table stored in the EBR sub-module comprises a valid bit, a row address, a column address, and bit data.

7. The memory repair apparatus having the hybrid error correction capability in claim 6, wherein the step of performing the preliminary repair by the EBR sub-module comprises:
reading the matched bit address and the matched bit data from the EBR table, performing calculation by a first logic gate to obtain a position data vector, and further performing calculation by a second logic gate on the row to be processed and the position data vector to obtain a bit-correction vector.

8. The memory repair apparatus having the hybrid error correction capability in claim 7, wherein the first logic gate is an AND gate, and wherein the second logic gate is an XOR gate.

9. The memory repair apparatus having the hybrid error correction capability in claim 1, when the DRAM is in the standby mode, performing a refresh operation according to the allowable refresh period being extended.

10. The memory repair apparatus having the hybrid error correction capability in claim 1, wherein the mode register is further coupled to the DRAM through a multiplexer, and when the mode register receives a command to switch the DRAM to the standby mode or the working mode, controlling the multiplexer to switch a controllabiltiy of the DRAM.

11. The memory repair apparatus having the hybrid error correction capability in claim 10, wherein the mode register is further coupled to a memory peripheral circuit to receive the command from the memory peripheral circuit.

12. The memory repair apparatus having the hybrid error correction capability in claim 11, wherein the memory peripheral circuit is a memory controller.

13. A hybrid error correction method, adapted to a memory repair apparatus to a DRAM, wherein the method comprises:
switching the DRAM to be controlled by a HEAR module when the DRAM enters a standby mode;
generating an error correction code by the HEAR module according to a refresh period;
extending the refresh period and performing an error detection process by the HEAR module to generate fail bit data of the DRAM until the refresh period is extended to an allowable refresh period; and
performing an error correction process by the HEAR module according to the fail bit data and writing corrected data into the DRAM before the DRAM exits from the standby mode.

14. The hybrid error correction method in claim 13, wherein the step of generating the error correction code by the HEAR module according to the refresh period further comprises:
reading original data from the DRAM row-wisely by the HEAR module to perform encoding and generating the error correction data.

15. The hybrid error correction method in claim 13, wherein after the step of generating the fail bit data, the hybrid error correction method further comprises:
employing an EBR table for storing the fail bit data.

16. The hybrid error correction method in claim 15, wherein the EBR table comprises a valid bit, a row address, a column address, and bit data.

17. The hybrid error correction method in claim 15, wherein when the DRAM performs the error correction process on a row to be processed, the hybrid error correction method further comprises:
performing a comparison between the row to be processed and the EBR table,
wherein if the comparison mismatches, performing repair on the row to be processed directly by an ECC sub-module in the HEAR module, and
wherein if the comparison matches, performing a prelimiary repair on the row to be processed by a EBR sub-module in the HEAR module and then performing a follow-up repair by the ECC sub-module.

18. The hybrid error correction method in claim 17, wherein the ECC sub-module employs a Bose, Chaudhuri & Hocquenghem (BCH) encoding and decoding method.

19. The hybrid error correction method in claim 17, when the ECC sub-module and the EBR sub-module altogether comprise a 2-bit error correction capability, controlling the EBR sub-module to repair a first-bit error and then controlling the ECC sub-module to repair a second-bit error.

20. The hybrid error correction method in claim 17, wherein the step of performing the prelimiary repair by the EBR sub-module comprises:
reading the matched bit address and the matched bit data from the EBR table;
performing calculation by a first logic gate to obtain a position data vector; and
performing calculation by a second logic gate on the row to be processed and the position data vector to obtain a bit correction vector.

21. The hybrid error correction method in claim 20, wherein the first logic gate is an AND gate, and wherein the second logic gate is an XOR gate.

22. The hybrid error correction method in claim 13, wherein when the DRAM is in the standby mode, the hybrid error-repair method further comprises:
controlling the DRAM to perform a refresh operation according to the allowable refresh period being extended.

23. The hybrid error correction method in claim 13 further comprising:
switching a controllabiltiy of the DRAM by setting a user-defined bit.
